(19) United States
(12) Patent Application Publication
(10) Pub. No.: US 2026/0252048 A1
(43) Pub. Date: Aug. 27, 2026

(54) COVERAGE ANALYSIS FOR A TEST INFRASTRUCTURE IN A COMPUTING ENVIRONMENT

(71) Applicant: Dell Products L.P., Round Rock, TX (US)

(72) Inventors: Vinay Sawal, Fremont, CA (US); Tsehsin Liu, Wellesley, MA (US); Bryan David Neumann, Garner, NC (US)

(21) Appl. No.: 19/065,636

(22) Filed: Feb. 27, 2025

(51) Int. Cl. G05B 15/02

(52) U.S. Cl. CPC G05B 15/02

(57) ABSTRACT

A method for managing a computing environment includes obtaining, by a coverage analysis system, a request for coverage analysis for a change, such as a test infrastructure, to a continuous integration and continuous delivery (CI/CD) deployment in the computing environment, in response to the request, the method further includes: performing a feature extraction of the CI/CD deployment to obtain a set of features, performing a feature engineering to obtain engineered features, performing a model training on a coverage analysis model based on the engineered features to obtain an updated coverage analysis model, performing an evaluation and optimization of the updated coverage model to obtain a finalized coverage analysis model that outputs a visualization of coverage of the CI/CD deployment for an input that comprises the change in the CI/CD deployment, and performing an integration of the coverage analysis model with the CI/CD deployment.

### BACKGROUND

Scheduling tasks in a computing environment may be complex relative to the number of tasks executing in the computing environment. As the number of tasks to be scheduled increases, the complexity of scheduling such tasks may increase proportionately or exponentially. Further, analyzing the impact of a test of the scheduled tasks may become complex in proportion, or exponentially, to the complexity of the scheduled tasks and the interdependent pipelines.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a diagram of a system in accordance with one or more embodiments of the invention.

FIG. 2 shows a flowchart of a method for generating and deploying an anomaly detection model in accordance with one or more embodiments of the invention.

FIG. 3A-3B shows an example diagram in accordance with one or more embodiments.

FIG. 4 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details, and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this disclosure, elements of figures may be labeled as A to N, A to P, A to M, or A to L. As used herein, the aforementioned labeling means that the element may include any number of items, and does not require that the element include the same number of elements as any other item labeled as A to N, A to P, A to M, or A to L. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

As used herein, the phrase operatively connected, operably connected, or operative connection, means that there exists between elements, components, and/or devices a direct or indirect connection that allows the elements to interact with one another in some way. For example, the phrase ‘operably connected’ may refer to any direct (e.g., wired directly between two devices or components) or indirect (e.g., wired and/or wireless connections between any number of devices or components connecting the operably connected devices) connection. Thus, any path through which information may travel may be considered an operable connection.

Embodiments of the invention include systems and methods for managing computing environments implementing the execution of tasks. The tasks may be collectively associated with a continuous integration and continuous delivery (CI/CD) use case. The CI/CD use case may be a deployment of computer-implemented services provided by and/or utilized by multiple organizations. The deployment of a CI/CD architecture may include the testing of execution of tasks, microservices, databases, and/or other computer-implemented services. In the CI/CD deployment, any change to one of the computer-implemented services (referred throughout the present disclosure as a node) may impact one or more other nodes in the CI/CD deployment. For such deployments that include thousands or millions of nodes and interdependent pipelines of multiple nodes, the impact of any change in the CI/CD deployment may not be immediately trackable.

For example, a test applied to at least a portion of the CI/CD deployment may provide results that indicate an impact to a second portion of the CI/CD deployment. However, the results of the test may not indicate the impact to the rest of the CI/CD deployment. Embodiments of the invention include functionality for analyzing the impact of a test infrastructure to a deployment of interdependent node. Such analyzed impact may be further referred to as a coverage. The coverage analysis may be performed by implementing feature calculations and feature engineering to generate a coverage analysis model for a given change (e.g., a test). The coverage analysis model may provide indication of a level of impact that the given change has on the CI/CD deployment, including the nodes, the dependencies on other nodes, and/or any other pipelines of the CI/CD deployment. The coverage analysis model may include, for example, a percentage of coverage of the given change to a given portion of the CI/CD deployment (or the entire CI/CD deployment) and a visualization of the coverage.

Embodiments of the invention may further include using the coverage analysis model to update the CI/CD deployment including updating the given change to increase its coverage, implementing the given change to advance the CI/CD deployment for future tests and/or changes to be analyzed, and/or making other changes to the CI/CD deployment without departing from the invention.

Various embodiments of the invention are described below.

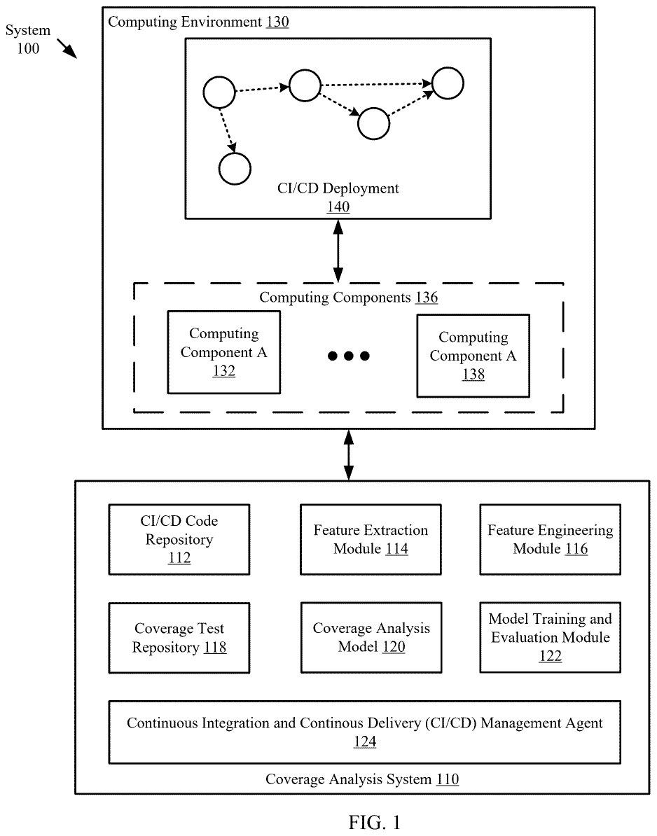

FIG. 1 shows a diagram of a system in accordance with one or more embodiments of the invention. The system (100) includes a computing environment (130) and a coverage analysis system (110). The system (100) of FIG. 1 may include additional, different, and/or different components without departing from the invention.

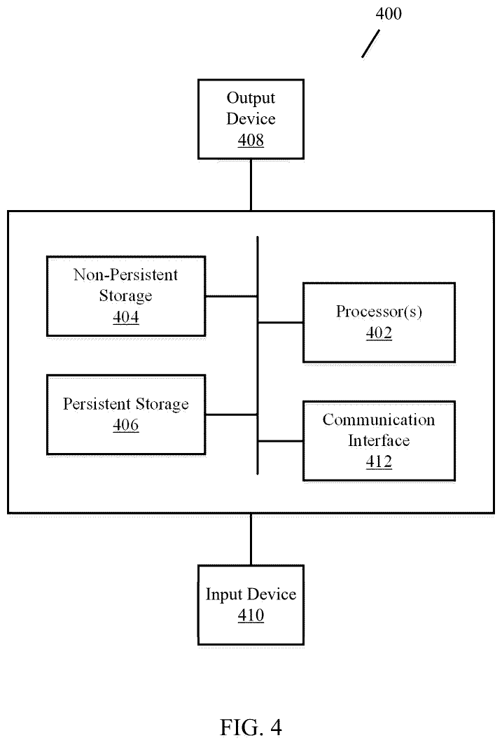

In one or more embodiments, the computing environment (130) includes functionality for providing computing services to users (not shown) or other entities. The computing environment (130) may be implemented as an environment of computing devices (see, e.g., FIG. 4). The computing devices may utilize any number of computing components (132, 138). Each computing component (132, 138) may be implemented as a computing device.

In one or more embodiments, the computing components (136) collectively execute a CI/CD deployment (140). In one or more embodiments, the CI/CD deployment (140) is an execution of tasks, mircoservices, database, classes, and/or other entities (also referred to as nodes) that may operate in the computing environment (130), be monitored using one or more of the nodes, updated based on planning and building performed by administrators, or one or more of the nodes, and include continuous testing based on the monitoring to update the CI/CD deployment (140).

In one or more embodiments, at least a portion of the computing components (132, 138) of the computing environment (130) undergo operational testing. The computing components (136) may undergo operational testing as implemented by the CI/CD deployment (140). For example, the computing components (136) may be implemented as a collection of servers, computers, storage devices, data centers, and/or other computing components without departing from the invention. The computing components (136) may be used by multiple organizations to execute the CI/CD deployment (140) without departing from the invention.

In one or more embodiments, the computing environment (130) is implemented as a computing device (see e.g., FIG. 4). The computing device may be, for example, a laptop computer, a desktop computer, a server, a distributed computing system, or a cloud resource (e.g., a third-party storage system accessible via a wired or wireless connection). The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the computing environment (130) described throughout this application.

In one or more embodiments disclosed herein, the computing environment (130) is implemented as a logical device. The logical device may utilize the computing resources of any number of computing devices and thereby provide the functionality of the computing environment (130) described throughout this application.

In one or more embodiments, the coverage analysis system (110) may include functionality for providing coverage analysis for any tests (or other changes) in the CI/CD deployment (140). To provide the aforementioned functionality, the coverage analysis system (110) includes a CI/CD code repository (112), a feature extraction module (114), a feature engineering module (116), a coverage test repository (118), a coverage analysis model (120), and a model training and evaluation module (122), and a CI/CD management agent (124). The coverage analysis may include additional, fewer, and/or different components without departing from the invention.

In one or more embodiments, the CI/CD code repository (112) is a data structure that includes the code that defines the CI/CD deployment (140). Any changes to the CI/CD deployment (140) may be defined using the CI/CD code repository (112). The CI/CD management agent (124) may implement any code in the CI/CD code repository (112) to provide the CI/CD deployment.

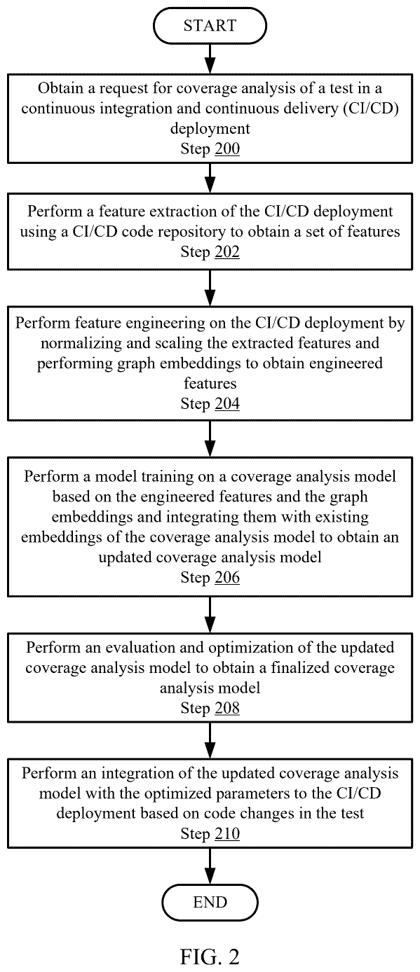

The feature extraction module (114) includes functionality for generating features in accordance with, for example, the method of FIG. 2. Further, the feature engineering module (116) includes functionality for performing a feature engineering in accordance with, for example, the method of FIG. 2. Similarly, the model training and evaluation module (122) includes functionality for performing a model training and a model evaluation of the coverage analysis model (120) in accordance with FIG. 2.

The coverage test repository (118) may be a data structure that includes one or more tests (or other stored and/or tracked changes) applied to the CI/CD deployment (140) and the corresponding results to the tests. The coverage test repository (118) may further store information about the coverage of a given test based on the coverage analysis performed in accordance with the method of FIG. 2.

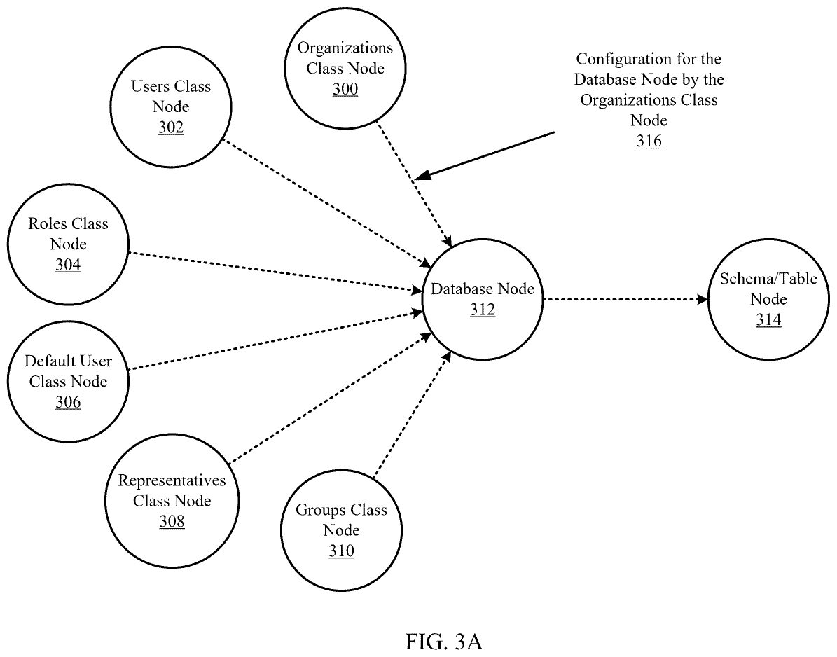

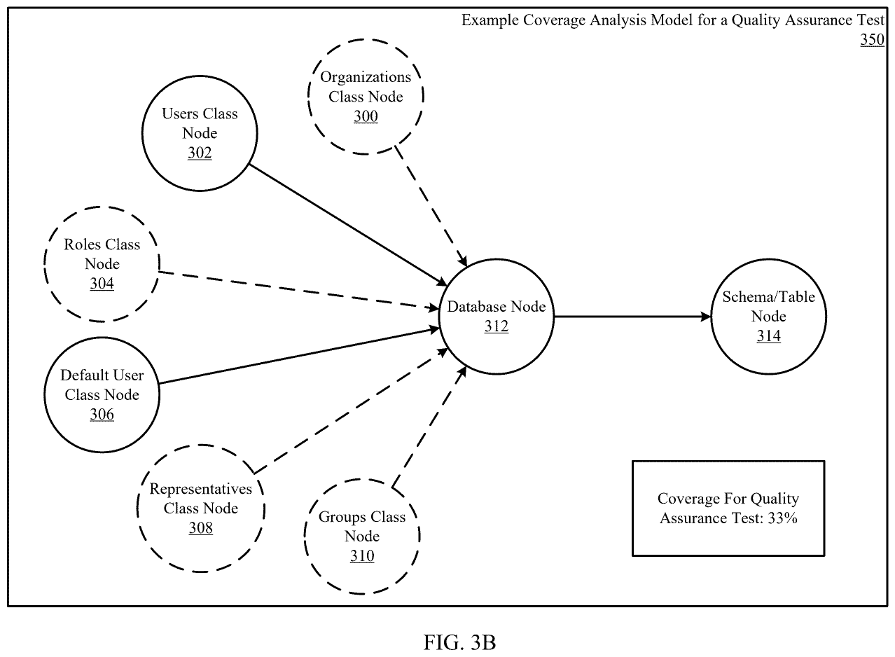

In one or more embodiments, the coverage analysis model (120) is a data structure that indicates coverage of a given test stored in the coverage test repository. The coverage analysis model (120) is generated in accordance with the method of FIG. 2 using the coverage test repository (118) and based on the CI/CD code repository (112) and the coverage test repository (118). In one or more embodiments, the coverage analysis model (120) includes an indication of the level (e.g., a percentage) of coverage that a given test applies to the CI/CD deployment (140). Further, the coverage analysis model (120) includes a visualization of the coverage associated with a given test. For an example coverage analysis model (120), refer to FIG. 3B.

In one or more embodiments, the coverage analysis system (110) (and/or any component illustrated within) is implemented as a computing device (see e.g., FIG. 5). The computing device may be, for example, a laptop computer, a desktop computer, a server, a distributed computing system, or a cloud resource (e.g., a third-party storage system accessible via a wired or wireless connection). The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the coverage analysis system (110) described throughout this application.

In one or more embodiments disclosed herein, the coverage analysis system (110) is implemented as a logical device. The logical device may utilize the computing resources of any number of computing devices and thereby provide the functionality of the coverage analysis system (110) described throughout this application.

FIG. 2 shows a flowchart of a method for generating and deploying an anomaly detection model in accordance with one or more embodiments of the invention. The method shown in FIG. 2 may be performed by, for example, a coverage analysis system (110, FIG. 1). Other components of the system illustrated in FIG. 1 may perform the method of FIG. 2 without departing from the invention. While the various steps in the flowchart are presented and described sequentially, one of ordinary skill in the relevant art will appreciate that some or all of the steps may be executed in different orders, may be combined or omitted, and some or all steps may be executed in parallel.

Turning to FIG. 2, in step 200, a request for coverage analysis of a test in a CI/CD deployment is obtained. In one or more embodiments, the request specifies the test (or other change) applied to the CI/CD deployment. Information associated with the test, including execution instructions, results, or other information, may be stored in the coverage test repository.

In step 202, a feature extraction is performed on the CI/CD deployment using a CI/CD code repository to obtain a set of features. In one or more embodiments, the feature extraction is derived from the CI/CD code repository and the coverage test repository. The set of features may include, for example, a cyclomatic complexity, dependency information, vector representations of the CI/CD deployment, metadata of portions of the CI/CD deployment, and invocation patterns in the CI/CD deployment.

In one or more embodiments, the cyclomatic complexity is a numerical value representing the complexity of a method (also referred to as a pipeline) in a CI/CD deployment and/or test based on a number of linearly independent paths in the method. It is calculated based on the control flow graph of the program. For each method or function, the cyclomatic complexity (M) may be computed as M=E−N+2P, where E is a number of edges in the method, N is the number of nodes, and P is the number of connected components. Static analysis tools may be used to calculate cyclomatic complexity for each method in the CI/CD code repository.

In one or more embodiments, the dependency information includes a dependency graph that maps methods, nodes, and/or other components of the CI/CD deployment and their interdependencies. The dependency graph may be generated using, for example, static analysis tools that parse an abstract syntax tree of the CI/CD code repository or the test code and identify dependencies in the nodes such as, for example method calls, inheritance, or data usage within methods.

The vector representations of the set of features may be represented as embeddings that capture semantic and syntactic features of the CI/CD code repository and/or the test code. The metadata of the CI/CD deployment may include, for example, information about the methods such as method length of each method, number of parameters in a method, a method access level (e.g., public, private, etc.), and/or any other metadata without departing from the invention.

The invocation patterns may include context and frequency of the methods invoked in the test repository that indicate a thoroughness of the test.

In step 204, a feature engineering is performed on the CI/CD deployment by normalizing and scaling the extracted features and by performing graph embeddings to obtain engineered features. In one or more embodiments, the feature engineering includes using the calculated cyclomatic complexities of each method in a test (or in the CI/CD deployment), the dependency information, and the embeddings to convert the dependency graph into feature vectors. The feature engineering may include scaling each cyclomatic complexity per the distribution to normalize its effect in the coverage analysis model. The feature engineering may further include generating adjacency matrices that indicate, for a given pair of nodes in the dependency graph, whether a dependency is present from one node in the pair to a second node in the pair. Additional embeddings generated from the dependency graph may include additional context and/or interactions between nodes and/or methods in the CI/CD deployment and/or in the test.

In step 206, a model training is performed on a coverage analysis model based on the engineered features and the graph embeddings. In one or more embodiments, the model training includes using the embeddings and/or vector representations generated in steps 202 and 204 to train the coverage analysis model using any machine learning algorithm (e.g., a classification, regression, etc.) to generate the coverage analysis model.

In step 208, an evaluation and optimization are performed on the coverage analysis model to obtain a finalized coverage analysis model. In one or more embodiments, the evaluation metrics are used for the optimization. For example, for classification algorithms, the evaluation metrics may include precision, recall, and F1-scores. As a second example, for regression algorithms, the evaluation metrics may include (MSE), (MAE), and r-squared values. For cross validation, a k-fold cross-validation technique and a hyperparameter tuning using, for example, grid search or random search techniques may be used for the evaluation and parameter optimization. The result is a finalized coverage analysis model with parameters optimized based on the evaluation.

In step 210, an integration of the finalized coverage analysis model is performed on the CI/CD deployment based on the code changes in the test. In one or more embodiments, the integration of the finalized coverage analysis model includes providing the coverage analysis model to the entity requesting the analysis (e.g., the entity issuing the request in step 200). The integration may further include applying changes to the test being analyzed for the purpose of increasing the coverage. Alternatively, the integration may include delaying the execution of changes to the CI/CD deployment based on the coverage analysis model.

### Example

To clarify aspects of the invention, the following describes an example in accordance with one or more embodiments of the invention. The example is illustrated in FIGS. 3A-3B. Turning to the example, consider a scenario in which a deployment of nodes includes classes of entities accessing a database that depends on a schema. FIG. 3A shows an example dependency graph of the deployment. The dependency graph includes an organizations class node (300), a users class node (302), a roles class node (304), a default user class node (306), a representatives class node (308), and a groups class node (310). Each of the aforementioned class nodes (300, 302, 304, 306, 308, 310) may utilize a configuration (e.g., 316) to access the database node (312). The configuration of each class node (300, 302, 304, 306, 308, 310) may include, for example, a pointer (e.g., a hyperlink) for accessing the database, login information associated with the corresponding class node (300, 302, 304, 306, 308, 310), a specified schema class of the corresponding class node (300, 302, 304, 306, 308, 310), and/or any other configurations without departing from the invention. In this example, there are six methods for accessing the schema/table node (312). Each of the six class node (300, 302, 304, 306, 308, 310) accessing the schema/table node (314) via their respective configurations are deemed one of the six methods.

In this example, a quality assurance (QA) test of the CI/CD deployment includes testing the operations of at least the users class node (302) and the default user class nodes (300) and their access to the schema (314) via the database (312). A request may be initiated in accordance with the method of FIG. 2 to obtain a coverage analysis of the QA test.

Turning to FIG. 3B, an example coverage analysis model for the QA test is shown. The example coverage analysis (350) includes a visualization of the dependency graph of the CI/CD deployment that indicates which methods have been tested for from the QA test. Given that the methods initiated by the organizations class node (300), roles class node (304), representatives class node (308), and groups class node (310) are not tested by the QA test. As such, only two out of six methods are covered by the QA test, and the example coverage analysis model (350) indicates the 2/6 (or 33%) coverage of the QA tested. The coverage analysis model (350) further includes a visualization of the coverage. In the example model (350) of FIG. 3B, the coverage is indicated by solid lines over the covered class nodes (302, 306) and corresponding configurations, and dashed lines over the class nodes (300, 304, 308, 310) and corresponding configurations that are not covered. In this manner, a developer of the QA test may update the test to cover more methods and may visualize which methods are not covered. Further, the visualization may aid in determining whether to proceed with implementing any changes introduced by the QA test.

### End of Example

As discussed above, embodiments of the invention may be implemented using computing devices. FIG. 4 shows a diagram of a computing device in accordance with one or more embodiments of the invention. The computing device (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment of the invention, the computer processor(s) (402) may be an integrated circuit for processing instructions. For example, the computer processor(s) may be one or more cores or micro-cores of a processor. The computing device (400) may also include one or more input devices (410), such as a touchscreen, keyboard, mouse, microphone, touchpad, electronic pen, or any other type of input device. Further, the communication interface (412) may include an integrated circuit for connecting the computer (400) to a network (not shown) (e.g., a local area network (LAN), a wide area network (WAN) such as the Internet, mobile network, or any other type of network) and/or to another device, such as another computing device.

In one embodiment of the invention, the computing device (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing devices exist, and the aforementioned input and output device(s) may take other forms.

One or more embodiments of the invention may be implemented using instructions executed by one or more processors of the data management device. Further, such instructions may correspond to computer readable instructions that are stored on one or more non-transitory computer readable mediums.

One or more embodiments of the invention may improve the operation of one or more computing devices. More specifically, embodiments of the invention provide robust multi-component coverage analysis of a computing environment to improve the operations of computer-implemented services in the computing environment. For example, embodiments of the invention generate coverage analysis models for changes made to a deployment of the services for the purposes of evaluating the impact of the changes to the overall infrastructure of the computing environment. By enabling users and/or developers of the system operating in the computing environment to identify the impact of a change to the deployment of services in the computing environment, the overall operation and infrastructure may be modified, monitored, developed, and/or otherwise used more efficiently. By combining machine learning techniques with cyclomatic complexity and dependency information of the infrastructure, embodiments of the invention may provide a holistic and data-driven approach to code coverage analysis. This approach may enable the development teams to identify coverage gaps, estimate the level and nature of risks associated with system changes, and prioritize testing efforts to ensure the stability and reliability of a cloud platform during frequent deployments.

Thus, embodiments of the invention may address the problem of inefficient use of computing resources. This problem arises due to the technological nature of the environment in which file systems are utilized.

The problems discussed above should be understood as being examples of problems solved by embodiments of the invention disclosed herein and the invention should not be limited to solving the same/similar problems. The disclosed invention is broadly applicable to address a range of problems beyond those discussed herein.

While the invention has been described above with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A method for managing a computing environment, the method comprising:
obtaining, by a coverage analysis system, a request for coverage analysis for a change to a continuous integration and continuous delivery (CI/CD) deployment in the computing environment;
in response to the request:
performing a feature extraction of the CI/CD deployment using a CI/CD code repository to obtain a set of features;
performing a feature engineering on the CI/CD deployment using a normalization and scaling of the set of features to obtain engineered features;
performing a model training on a coverage analysis model based on the engineered features to obtain an updated coverage analysis model;
performing an evaluation and optimization of the updated coverage model to obtain a finalized coverage analysis model,
wherein the finalized coverage analysis model outputs a visualization of coverage of the CI/CD deployment for an input that comprises the change in the CI/CD deployment; and
performing an integration of the coverage analysis model with the CI/CD deployment.

2. The method of claim 1, wherein the CI/CD deployment comprises a plurality of interdependent pipelines implemented using a plurality of nodes.

3. The method of claim 2, wherein the integration of the coverage analysis model with the CI/CD deployment comprises:
modifying the change in the CI/CD deployment to increase the coverage of the CI/CD deployment.

4. The method of claim 2, wherein the change in the CI/CD deployment is a test applied to a portion of the CI/CD deployment.

5. The method of claim 2, wherein the visualization of coverage is represented using a dependency graph of the plurality of nodes and plurality of interdependent pipelines.

6. The method of claim 1, further comprising:
obtaining, by the coverage analysis system, a second request for coverage analysis for a second change to the CI/CD deployment;
in response to the second request:
inputting the second change to the finalized coverage analysis model to obtain a second visualization of second coverage of the CI/CD deployment by the second change; and
based on the second coverage, modifying the second change to increase the second coverage.

7. The method of claim 1, wherein the set of features comprises: a cyclomatic complexity of the CI/CD deployment, dependency information, vector representations of the CI/CD deployment, metadata of portions of the CI/CD deployment, and invocation patterns in the CI/CD deployment.

8. A non-transitory computer readable medium comprising computer readable program code, which when executed by a computer processor enables the computer processor to perform a method for managing a computing environment, the method comprising:
obtaining, by a coverage analysis system, a request for coverage analysis for a change to a continuous integration and continuous delivery (CI/CD) deployment in the computing environment;
in response to the request:
performing a feature extraction of the CI/CD deployment using a CI/CD code repository to obtain a set of features;
performing a feature engineering on the CI/CD deployment using a normalization and scaling of the set of features to obtain engineered features;
performing a model training on a coverage analysis model based on the engineered features to obtain an updated coverage analysis model;
performing an evaluation and optimization of the updated coverage model to obtain a finalized coverage analysis model,
wherein the finalized coverage analysis model outputs a visualization of coverage of the CI/CD deployment for an input that comprises the change in the CI/CD deployment; and
performing an integration of the coverage analysis model with the CI/CD deployment.

9. The non-transitory computer readable medium of claim 8, wherein the CI/CD deployment comprises a plurality of interdependent pipelines implemented using a plurality of nodes.

10. The non-transitory computer readable medium of claim 9, wherein the integration of the coverage analysis model with the CI/CD deployment comprises:
modifying the change in the CI/CD deployment to increase the coverage of the CI/CD deployment.

11. The non-transitory computer readable medium of claim 9, wherein the change in the CI/CD deployment is a test applied to a portion of the CI/CD deployment.

12. The non-transitory computer readable medium of claim 9, wherein the visualization of coverage is represented using a dependency graph of the plurality of nodes and plurality of interdependent pipelines.

13. The non-transitory computer readable medium of claim 8, further comprising:
obtaining, by the coverage analysis system, a second request for coverage analysis for a second change to the CI/CD deployment;
in response to the second request:
inputting the second change to the finalized coverage analysis model to obtain a second visualization of second coverage of the CI/CD deployment by the second change; and
based on the second coverage, modifying the second change to increase the second coverage.

14. The non-transitory computer readable medium of claim 8, wherein the set of features comprises: a cyclomatic complexity of the CI/CD deployment, dependency information, vector representations of the CI/CD deployment, metadata of portions of the CI/CD deployment, and invocation patterns in the CI/CD deployment.

15. A system, comprising:
a computing environment;
a coverage analysis system operating on a processor; and
memory comprising instructions, which when executed by the processor, perform a method comprising:
obtaining a request for coverage analysis for a change to a continuous integration and continuous delivery (CI/CD) deployment in the computing environment, wherein the change in the CI/CD deployment is a test applied to a portion of the CI/CD deployment;
in response to the request:
performing a feature extraction of the CI/CD deployment using a CI/CD code repository to obtain a set of features;
performing a feature engineering on the CI/CD deployment using a normalization and scaling of the set of features to obtain engineered features;
performing a model training on a coverage analysis model based on the engineered features to obtain an updated coverage analysis model;
performing an evaluation and optimization of the updated coverage model to obtain a finalized coverage analysis model,
wherein the finalized coverage analysis model outputs a visualization of coverage of the CI/CD deployment for an input that comprises the change in the CI/CD deployment; and
performing an integration of the coverage analysis model with the CI/CD deployment.

16. The system of claim 15, wherein the CI/CD deployment comprises a plurality of interdependent pipelines implemented using a plurality of nodes.

17. The system of claim 16, wherein the integration of the coverage analysis model with the CI/CD deployment comprises:
modifying the change in the CI/CD deployment to increase the coverage of the CI/CD deployment.

18. The system of claim 16, wherein the visualization of coverage is represented using a dependency graph of the plurality of nodes and plurality of interdependent pipelines.

19. The system of claim 15, further comprising:
obtaining, by the coverage analysis system, a second request for coverage analysis for a second change to the CI/CD deployment;
in response to the second request:
inputting the second change to the finalized coverage analysis model to obtain a second visualization of second coverage of the CI/CD deployment by the second change; and
based on the second coverage, modifying the second change to increase the second coverage.

20. The system of claim 15, wherein the set of features comprises: a cyclomatic complexity of the CI/CD deployment, dependency information, vector representations of the CI/CD deployment, metadata of portions of the CI/CD deployment, and invocation patterns in the CI/CD deployment.
